(19) United States
(12) Patent Application Publication
(10) Pub. No.: US 2025/0113064 A1
(43) Pub. Date: Apr. 3, 2025

(54) TECHNIQUES FOR DEBANDING IN THE INVERSE TRANSFORM STAGE OF A VIDEO CODING PIPELINE

(71) Applicant: NETFLIX, INC., Los Gatos, CA (US)

(72) Inventor: Andrey NORKIN, Campbell (U)

(21) Appl. No.: 18/904,036

(22) Filed: Oct. 1, 2024

Related U.S. Application Data
(60) Provisional application No. 63/587,406, filed on Oct. 2, 2023.
(60) Provisional application No. 63/588,667, filed on Oct. 6, 2023.

(51) Int. Cl. H04N 19/86; H04N 19/124; H04N 19/132; H04N 19/136; H04N 19/176; H04N 19/625

(52) U.S. Cl. CPC H04N 19/86; H04N 19/124; H04N 19/132; H04N 19/136; H04N 19/176; H04N 19/625

(57) ABSTRACT

In various embodiments, a technique for reducing banding artifacts in decoded video data includes performing a set of transform operations on a first block of coefficients associated with a frame of encoded video data to generate a first block of samples, determining that a first sample included in the first block of samples meets a first criterion, generating a first randomized value based on at least one attribute of the first sample, modifying a first sample value associated with the first sample based on the first randomized value to generate a first dithered sample value, and generating a first portion of decoded video data based on the first dithered sample value.

### CROSS-REFERENCE TO RELATED APPLICATIONS

This application claims the benefit of U.S. Provisional Application titled “TECHNIQUES FOR DEBANDING IN VIDEO CODING,” filed on Oct. 2, 2023, and having Ser. No. 63/587,406, and “TECHNIQUES FOR DEBANDING IN VIDEO CODING,” filed on Oct. 6, 2023, and having Ser. No. 63/588,667. The subject matter of these related applications is hereby incorporated by reference.

### BACKGROUND

### Field of the Various Embodiments

Embodiments of the present disclosure relate generally to computer science and video processing and, more specifically, to techniques for debanding in video coding.

### Description of the Related Art

Video content from a media title is commonly encoded to reduce the size of the video content and to convert the content into a format that is more suitable for broadcast, transmission, or playback on various devices or platforms. For example, video content from a movie or television show could be encoded into multiple versions that can be streamed to different endpoint devices. Each version of the video content could be associated with a certain encoding format, bit rate, frame rate, resolution, level of quantization, or other encoding settings that are optimized for streaming or playback on a particular set of endpoint device hardware and/or under a given set of network conditions. During encoding of video content from a media title, each video frame is divided into multiple blocks of fixed or varying sizes, and the portion of video content within each block is encoded. During playback of the media title on an endpoint device, the encoded blocks can be decoded and used to reconstruct the video frame.

In some instances, the encoding and decoding process described above introduces “banding” artifacts into reconstructed video frames. Banding artifacts are visual disruptions and/or distortions in reconstructed video frames that are not present in the original video content. Banding artifacts visually appear as striped regions and can sometimes be found in areas of a reconstructed video frame where a smooth transition between colors would otherwise occur. For example, banding artifacts are sometimes visible in portions of reconstructed video frames that are meant to depict a clear sky. Rather than depicting a smooth transition across many similar shades of blue, when banding artifacts are present, portions of the reconstructed video frames would instead display several abrupt transitions between just a few different shades of blue. As a general matter, banding artifacts are visually unappealing and are usually distracting to most viewers.

Banding artifacts can occur in many different coding implementations. Banding artifacts sometimes occur when directional intra-prediction coding techniques are used to encode and decode video content at higher quantization settings. In particular, the higher quantization settings can cause blocks/stretches of similar pixels to appear in reference samples. When the reference samples are subsequently used to reconstruct a portion of the video frame, these blocks are then replicated along the prediction direction, introducing a continuous region or “band” of similarly valued pixels into the portion of the reconstructed video frame. For example, when the prediction direction is top-to-bottom and left-to-right, blocks of similar pixels can sometimes be replicated across a portion of the reconstructed video frame, forming a diagonal band that extends from an upper-left area of the portion of the reconstructed video frame towards a lower-right area of the portion of the reconstructed video frame.

One approach to reducing banding is to perform “debanding” post-processing operations on each reconstructed video frame after decoding has occurred. During debanding post-processing, each reconstructed video frame is analyzed by hardware and/or software on the endpoint device to detect whether the reconstructed video frame includes any banding artifacts. To the extent banding artifacts are detected within a given reconstructed video frame, that reconstructed video frame is modified to reduce the visual impact of the detected banding artifacts. One drawback of this approach is that debanding post-processing operations are typically computationally intensive. Another drawback is that different endpoint devices typically implement different debanding post-processing operations due to varying hardware and/or software configurations, which can lead to inconsistent reductions in banding and inconsistent levels of visual quality across different endpoint devices.

As the foregoing illustrates, what is needed in the art are more effective techniques for reducing banding artifacts in decoded video data.

### SUMMARY

In various embodiments, a technique for reducing banding artifacts in decoded video data includes performing a set of transform operations on a first block of coefficients associated with a frame of encoded video data to generate a first block of samples, determining that a first sample included in the first block of samples meets a first criterion, generating a first randomized value based on at least one attribute of the first sample, modifying a first sample value associated with the first sample based on the first randomized value to generate a first dithered sample value, and generating a first portion of decoded video data based on the first dithered sample value.

At least one technical advantage of the disclosed techniques relative to the prior art is that the disclosed techniques enable the decoding pipeline to reduce the appearance of banding artifacts in reconstructed frames of video data, thereby resulting in greater overall visual quality and higher-quality viewing experiences when streaming media titles. Another technical advantage of the disclosed techniques is that filtering reference samples during intra-prediction does not require the addition of any post-processing operations to the decoding pipeline. Accordingly, the disclosed techniques can be implemented without introducing additional blocks to the video decoding and processing pipeline. Yet another technical advantage of the disclosed techniques is that the disclosed decoding pipeline can be deployed to different types of endpoint devices, which can lead to more consistent debanding performance and visual quality across different endpoint devices having different hardware and/or software configurations. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a block diagram of a content server that may be implemented in conjunction with the network infrastructure of FIG. 1, according to various embodiments;

FIG. 3 is a block diagram of a control server that may be implemented in conjunction with the network infrastructure of FIG. 1, according to various embodiments; and

FIG. 4 is a block diagram of an endpoint device that may be implemented in conjunction with the network infrastructure of FIG. 1, according to various embodiments;

FIG. 5 is a more detailed illustration of the decoding pipeline of FIG. 4, according to various embodiments;

FIG. 6 is a more detailed illustration of the inverse transform stage of FIG. 5, according to various embodiments; and

FIG. 7 is a flow diagram of method steps for generating a residual frame of sample values when decoding an encoded video frame, according to various embodiments.

### DETAILED DESCRIPTION

In the following description, numerous specific details are set forth to provide a more thorough understanding of the embodiments of the present invention. However, it will be apparent to one of skill in the art that the embodiments of the present invention may be practiced without one or more of these specific details.

Banding artifacts are visual disruptions and/or distortions in reconstructed video frames that are not present in the original video content. Banding artifacts visually appear as striped regions and can sometimes be found in areas of a reconstructed video frame where a smooth transition between colors would otherwise occur. Banding artifacts can occur in many different coding implementations. For example, banding artifacts are sometimes caused by the inverse transform stage of a coding pipeline when a residual frame of sample values is decoded and used to generate a reconstructed frame of video data. More specifically, during a typical inverse transform stage, the coefficients for the residual frame of sample values are transformed from the frequency domain back to the spatial domain. The resultant frame of residual sample values, which represent the difference between predicted sample values and actual sample values, is used in conjunction with predicted sample values to generate the reconstructed frame of video data. Pixel values associated with the reconstructed frame of video data are typically then downsampled to a desired bit depth. However, many conventional decoding pipelines, when downsampling to the desired bit depth, typically round slightly different pixel values to the same value. Consequently, continuous regions or “bands” of similarly-valued pixels can appear as visible banding artifacts to viewers of the reconstructed frame.

One approach to reducing banding is to perform “debanding” post-processing operations on each reconstructed video frame after decoding has occurred. During debanding post-processing, each reconstructed video frame is analyzed by hardware and/or software on the endpoint device to detect whether the reconstructed video frame includes any banding artifacts. To the extent banding artifacts are detected within a given reconstructed video frame, that reconstructed video frame is modified to reduce the visual impact of the detected banding artifacts. One drawback of this approach is that debanding post-processing operations are typically computationally intensive. Another drawback is that different endpoint devices typically implement different debanding post-processing operations due to varying hardware and/or software configurations, which can lead to inconsistent reductions in banding and inconsistent levels of visual quality across different endpoint devices.

To address the above issues, a decoding pipeline is configured to implement an inverse transform stage that incorporates a randomized dithering operation. The inverse transform stage includes a row transform stage and column transform stage that perform row-based and column-based inverse transform operations, respectively, based on a set of dequantized coefficients to generate a reconstructed version of a residual block of sample values. For a given sample in the reconstructed version of the residual block, a randomization function generates a randomized value based on one or more attributes of the sample. The randomized value is combined with a sample value associated with the sample to generate a randomized sample value. A rounding function then rounds the randomized sample value to a lower bit depth to generate a dithered sample value. The randomized dithering operation can be selectively performed on specific blocks of coefficients that meet certain criteria.

At least one technical advantage of the disclosed techniques relative to the prior art is that the disclosed techniques enable the decoding pipeline to reduce the appearance of banding artifacts in reconstructed frames of video data, thereby resulting in greater overall visual quality and higher-quality viewing experiences when streaming media titles. Another technical advantage of the disclosed techniques is that incorporating randomized dithering operations into the inverse transform stage does not require the addition of any post-processing operations to the decoding pipeline. Accordingly, the disclosed techniques can be implemented without introducing significant delays during playback of a media title. Yet another technical advantage of the disclosed techniques is that the disclosed decoding pipeline can be deployed to different types of endpoint devices, which can lead to more consistent debanding performance and visual quality across different endpoint devices having different hardware and/or software configurations. These technical advantages provide one or more technological improvements over prior art approaches.

### System Overview

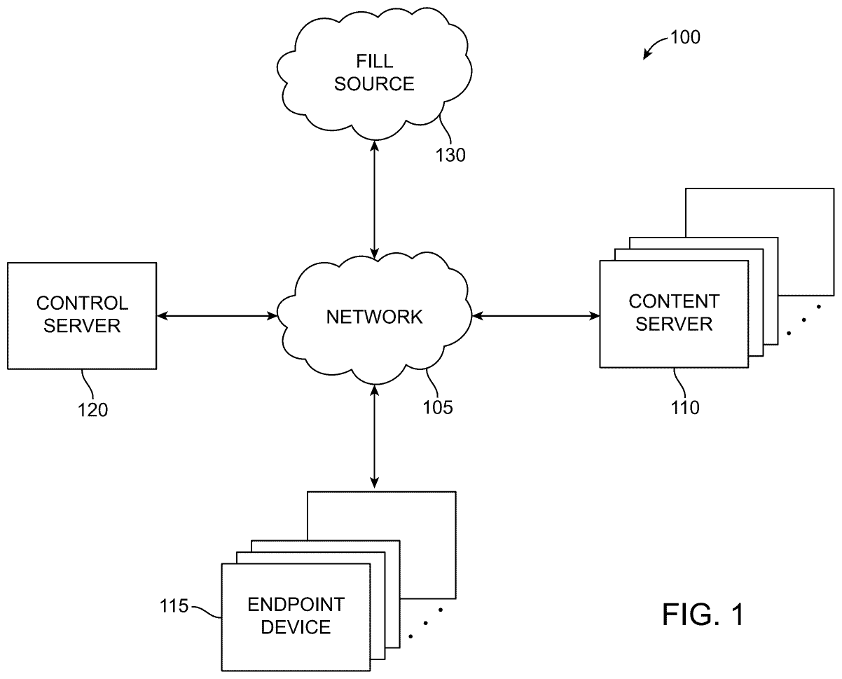

FIG. 1 illustrates a network infrastructure 100 used to distribute content to content servers 110 and endpoint devices 115, according to various embodiments. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, database, and server application 217 configured to communicate with the control server 120 to determine the location and availability of various files that are tracked and managed by the control server 120. Each content server 110 may further communicate with a fill source 130 and one or more other content servers 110 in order “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

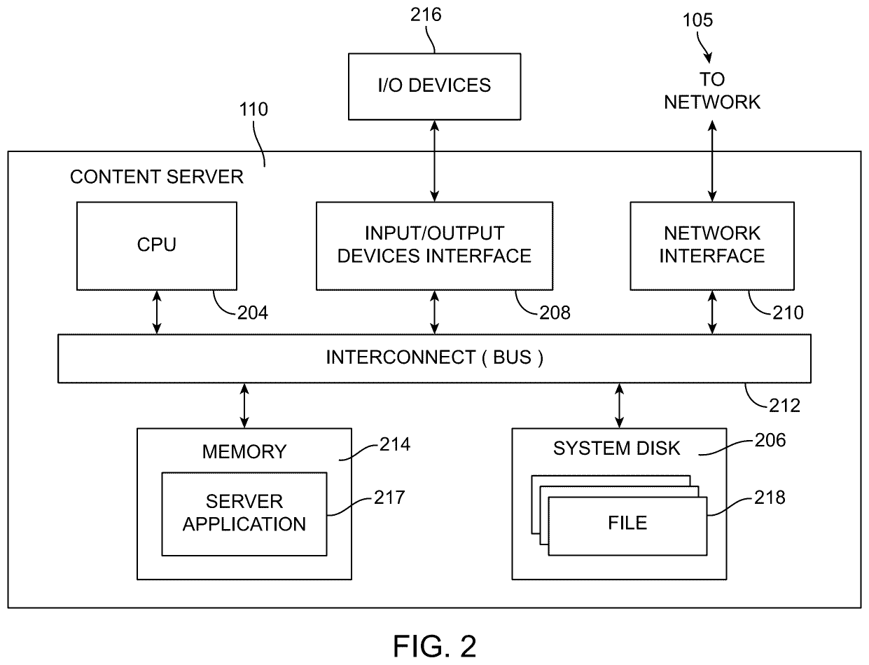

FIG. 2 is a block diagram of a content server 110 that may be implemented in conjunction with the network infrastructure 100 of FIG. 1, according to various embodiments. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid state storage devices, or similar storage devices. The system disk 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the system disk 206 and transmits the file 218 to an endpoint device 115 or a content server 110 via the network 105.

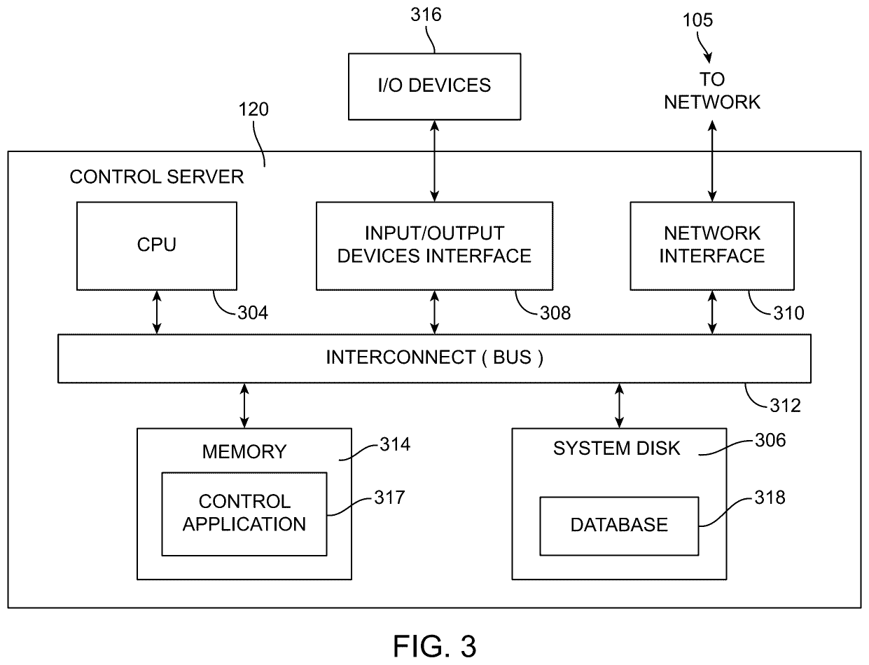

FIG. 3 is a block diagram of a control server 120 that may be implemented in conjunction with the network infrastructure 100 of FIG. 1, according to various embodiments. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the system disk 306. The interconnect 312 is configured to facilitate transmission of data between the CPU 304, the system disk 306, I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid state storage devices, and the like. The system disk 206 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

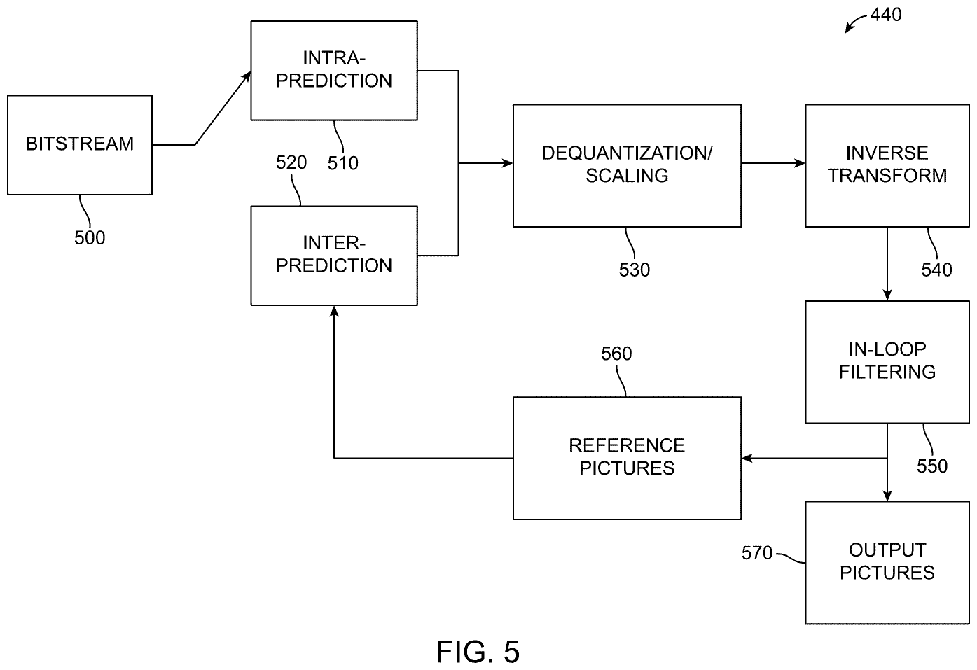

Referring generally to FIGS. 1-3, in various embodiments, the system 100 is configured to implement an encoding pipeline to compress audiovisual data associated with media titles prior to streaming to endpoint device(s) 115. For example, and without limitation, the content server 110 of FIGS. 1-2 could implement an encoding pipeline via server application 217 that compresses files 218 prior to transmission to an endpoint device 115. Alternatively, and without limitation, files stored in fill source 130 could be compressed, via an encoding pipeline within system 100, prior to storage. As described in greater detail below in conjunction with FIGS. 5-7, the encoding pipeline can analyze audiovisual data during encoding to determine specific optimizations that can subsequently be applied, during decoding on endpoint device 115, to reduce the presence of banding artifacts.

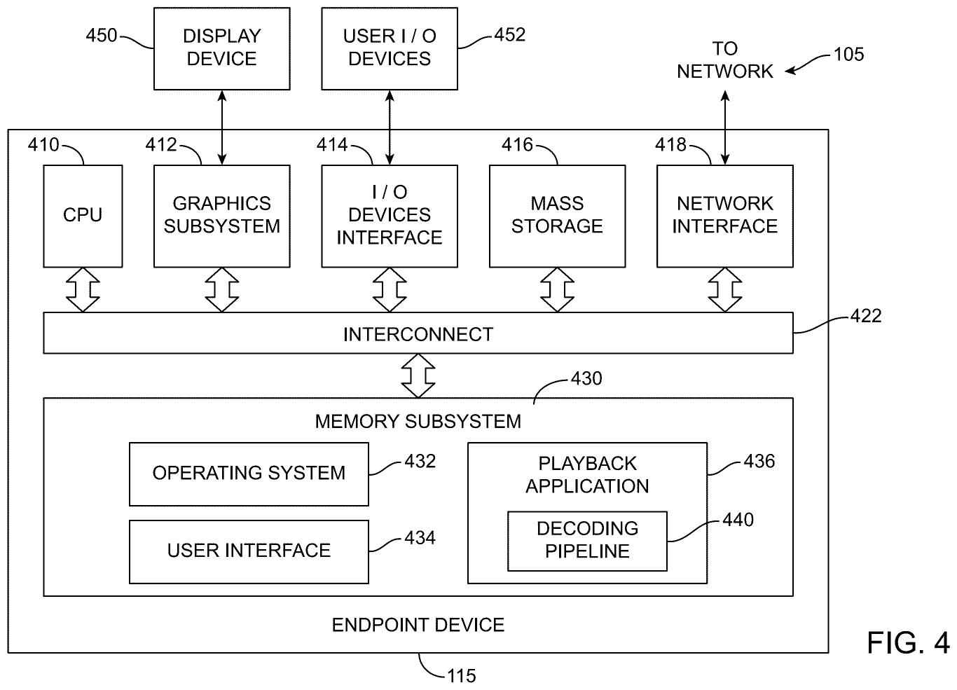

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage unit 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage unit 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage unit 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 108. Persons skilled in the art will recognize the various operating systems and user interfaces that are well-known in the art and suitable for incorporation into the endpoint device 108.

In some embodiments, the playback application 436 is configured to request and receive content from the content server 105 via the network interface 418. Further, the playback application 436 is configured to interpret the content and present the content via display device 450 and/or user I/O devices 452. In so doing, the playback application 436 includes a decoding pipeline 440 that decodes compressed content prior to display via display device. Decoding pipeline 440 is described in greater detail below in conjunction with FIG. 5.

### Debanding in Video Coding

FIG. 5 is a more detailed illustration of the decoding pipeline of FIG. 4, according to various embodiments. As shown, decoding pipeline 440 receives bitstream 500 and generates output pictures 570. Bitstream 500 generally includes compressed frames of video data, whereas output pictures 570 includes decompressed frames of video data. Decoding pipeline 440 includes various decoding stages, including intra-prediction 510, inter-prediction 520, dequantization/descaling 530, inverse transform 540, and in-loop filtering 550.

Intra-prediction 510 is a decoding stage that generates reconstructed frames of video data using intra-prediction decoding techniques. Inter-prediction 520 is a decoding stage that can generate reconstructed frames of video data using inter-prediction decoding techniques. Dequantization/scaling 530 is a decoding stage where various quantized coefficients are scaled based on one or more quantization parameters. Inverse transform 540 is a decoding stage that converts scaled coefficients output by dequantization/scaling 530 between different domains. In-loop filtering 550 is a decoding stage that applies various filters to reconstructed frames of video data. In-loop filtering 550 generates reference pictures 560 that can be subsequently used by inter-prediction 520, as well as output pictures 570 mentioned above, which can be displayed via display device 450.

Various stages of decoding pipeline 440 can be configured to implement specific operations that can reduce the presence of banding artifacts in output pictures 570. In particular, intra-prediction 510, inverse transform 540, and in-loop transform 550 can each be configured to implement different types of filtering and/or randomized dithering operations to mitigate or at least partially prevent banding artifacts. These operations can be performed by the decoding stages mentioned above independently of one another or in any technically feasible combination with one another.

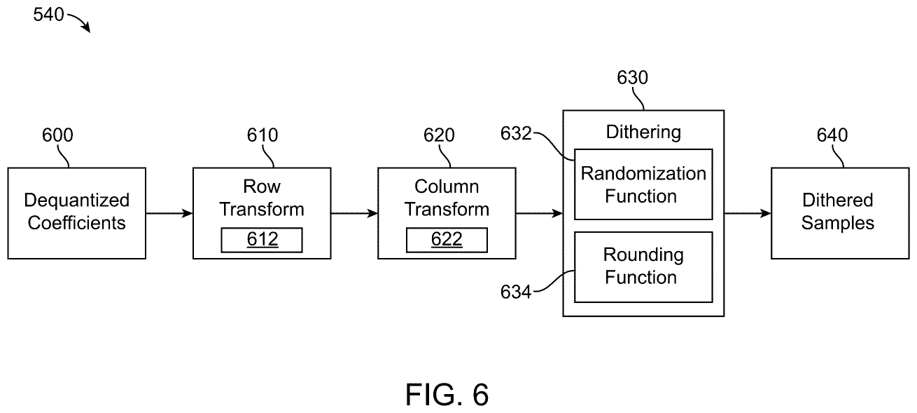

In various embodiments, during encoding of compressed frames of video data included in bitstream 500, an encoding pipeline analyzes frames of video data and determines, for a given set of frames, specific combinations and/or configurations of decoding stages that should implement the aforesaid operations during decoding to reduce banding artifacts in that set of frames. For example, and without limitation, the encoding pipeline could determine that for a given set of frames, intra-prediction 510 should filter reference samples using specific parameters, inverse transform 540 should implement randomized dithering operations, and in-loop filtering 550 should operate using an increased bit depth. The encoding pipeline may implement any technically feasible criteria to determine which configurations to apply when decoding any given set of frames. Various operations that can be implemented by inverse transform 540 are described in greater detail below in conjunction with FIG. 6.

FIG. 6 is a more detailed illustration of the inverse transform stage of FIG. 5, according to various embodiments. As shown, inverse transform 540 receives dequantized coefficients 600 and generates dithered samples 640. Dequantized coefficients 600 are provided by dequantization/scaling 530 of FIG. 5 and generally include one or more blocks of coefficients that describe at least a portion of a residual frame of sample values in the frequency domain. Dithered samples 640 represent at least a portion of the residual frame of sample values in the spatial domain.

Inverse transform 540 includes row transform 610, column transform 620, and dithering 630. In operation, row transform 610 implements a row-based inverse transform operation on dequantized coefficients 600 to generate a row-transformed portion 612 of the residual frame of sample values. Column transform 620 then implements a column-based inverse transform operation on row-transformed portion 612 to generate a reconstructed version 622 of the residual frame of sample values. In one embodiment, row transform 610 may upscale dequantized coefficients 600 to a higher bit depth prior to processing.

Dithering 630 performs a randomized dithering operation with reconstructed version 622 of the residual frame of sample values to generate dithered samples 640. In one embodiment, dithered samples 640 may have a lower bit depth than that used by row transform 610 and/or column transform 620. This lower bit depth may correspond to the bit depth of output pictures 570. Dithering 630 includes a randomization function 632 and a rounding function 634.

For a given sample in reconstructed version 622 of the residual frame of sample values, randomization function 632 generates a randomized value that is added to a sample value associated with the sample, thereby generating a randomized sample value. In one embodiment, randomization function 632 generates the randomized value based on a set of coordinates associated with the sample. The set of coordinates may be local coordinates or global coordinates. Rounding function 634 then performs a rounding operation with the randomized sample value to generate a dithered value for the sample. Dithered samples 640 include samples that have been subject to the randomized dithering operation described above. An exemplary randomization function is denoted below, without limitation:

$$rand ( i , j ) = ra\_num [ ( {j}^{*} mcol + {i}^{*} mrow ) \& 31 ] \qquad ( 1 )$$

$$ra\_num \_part [ 32 ] = \{ 12 , 0 , 6 , 4 , 15 , 12 , 6 , 11 , 11 , 9 , 15 , \\ 12 , 9 , 1 , 14 , 4 , 7 , 5 , 12 , 13 , 13 , 14 , 1 , 11 , 8 , 5 , 9 , 6 , 3 , 4 , 2 , 2 \} \qquad ( 2 )$$

In expression (1), i and j are vertical and horizontal coordinates, respectively, of a given sample, and mrow and mcol are multipliers for those coordinates, respectively. Expression (2) is a pseudo-random array that is indexed in the manner shown in expression (1) based on i, j, mrow, and mcol. Randomization function 632 can implement expressions (1) and (2) in order to generate randomized values that are derived from positional attributes of samples. In various embodiments, randomization function 632 may implement other randomization functions and generate randomized values based on other attributes of samples. An exemplary rounding function is denoted below, without limitation:

$${{x}_{ij}}^{′} = ( {x}_{sum , ij} + rand ( i , j ) ) ≫ s \qquad ( 3 )$$

In expression (3), a bit shift operation is applied after a randomized value is added to the sample value. The value of s determines the extent of the bit shift and therefore the bit depth of dithered samples 640. Here, the rounding function denoted by expression (3) incorporates the exemplary randomization function denoted in expression (1), described above.

In some embodiments, dithering 630 selectively applies the randomized dithering operation described above to some portions of reconstructed version 622 and not others. Dithering 630 may select portions of reconstructed version 622 based on various attributes of dequantized coefficients 600, row-transformed portion 612 of the residual frame of sample values, and/or reconstructed version 622 of the residual frame of sample values. Alternatively, dithering 630 can perform the randomized dithering operation for specific sets of dequantized coefficients 600 and not others. An exemplary condition that dithering 630 can apply is denoted below, without limitation:

$$if ( ! plane \&\& bw + bh >= edge\_len \&\& num\_nz <= num\_nz \_thr ) \qquad ( 4 )$$

In condition (4), num_nz is the number of non-zero coefficients in a block of coefficients within dequantized coefficients 600, and bw and bh are width and height values of the block, respectively. In addition, num_nz_thr is a threshold that may be set based on block size and/or other parameters sent via bitstream 500. In one embodiment, num_nz_thr may be set to the maximum value of the sum of row and column indices of non-zero coefficients in the block. An example of how this operation can be performed is denoted below, without limitation:

$$num\_nz \_thr = {kmult}^{*} ( bw + bh ) ≫ coeff\_num \_shift \qquad ( 5 )$$

In expression (5), kmult and coeff_num_shift are parameters that correspond to a certain diagonal in the block, and the comparison between num_nz and num_nz_thr indicates that there are non-zero coefficients below that diagonal, which correspond to low-frequency basis images. An alternative exemplary approach for determining num_nz_thr is denoted below, without limitation:

```
if (q_index > 110){
  edge_len = SMOOTH_TX_BLOCK_SIZE;
  num_nz_thr = TX_EOB_SMOOTH;
} else if (q_index > 80) {
  edge_len = 12;
  num_nz_thr = TX_EOB_SMOOTH;
} else {
  edge_len = 8;
  num_nz_thr = (bw <= 8 && bh <= 8) ? TX_EOB_SMALL : TX_EOB_SMOOTH;
```

| | |
|---|---|
| } | (6) |

In expression (6), num_nz_thr is set in a manner that causes the randomized dithering operation to be performed for smaller blocks having a lower quantization parameter. In some embodiments, dithering 630 may be disabled for blocks that have high-frequency coefficients in dequantized coefficients 630 by comparing the number of non-zero coefficient values associated with a given range of frequency values to a threshold, where the threshold may depend on transform size and/or transform gain values associated with row transform 610 and/or column transform 620. In various embodiments, the randomized dithering operation can be applied to luma components only or, alternatively, to both luma and chroma components. In one embodiment, intra-prediction 510 and/or inter-prediction 520 may implement a higher bit depth when dithering 530 is active and implement a lower bit depth when dithering 530 is inactive.

Via the techniques described above, dithering 630 generates dithered samples 640 which can then be processed by in-loop filtering 550 to generate frames of decoded video data included in output pictures 570. The randomized dithering approach described thus far advantageously reduces banding artifacts by preventing the formation of well-defined and abrupt gradients between color values.

In various embodiments, intra-prediction 510 and/or in-loop filtering 550 within decoding pipeline 440 of FIG. 5 may implement randomized dithering operations such as those described above. Referring generally to FIGS. 4-6, decoding pipeline 440 and the various components described can implement any combination of the disclosed techniques independently or in conjunction with one another in order to reduce banding artifacts. Further, persons skilled in the art will understand how the techniques described herein relative to decoding pipeline 440 can also be implemented within analogous stages of a corresponding encoding pipeline. For example, and without limitation, the various operations described above with regard to in-loop filtering 550 could also be implemented within an in-loop filtering stage of an encoding pipeline.

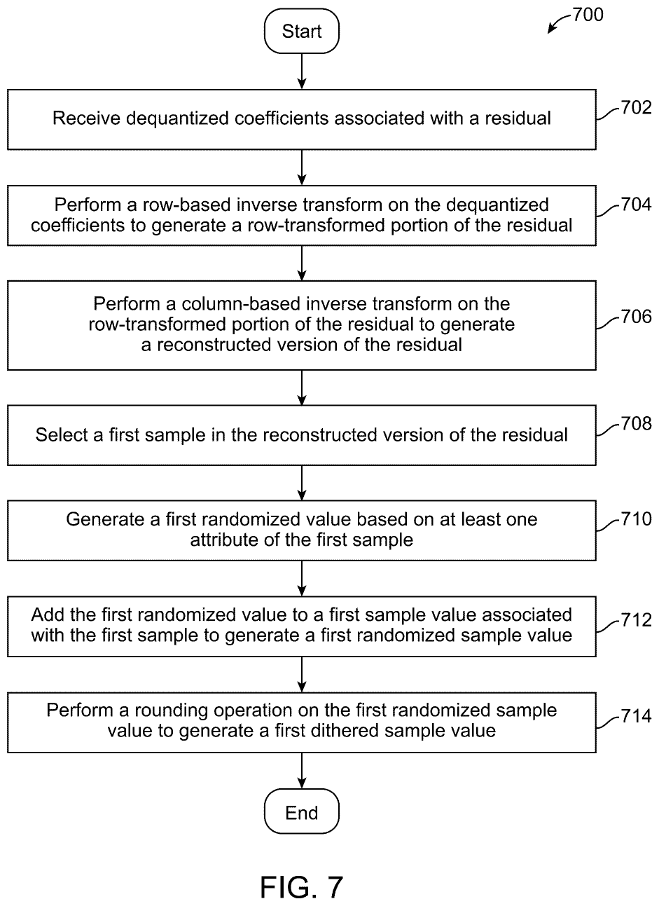

FIG. 7 is a flow diagram of method steps for generating a residual frame of sample values when decoding an encoded video frame, according to various embodiments. Although the method steps are described in conjunction with the systems of FIGS. 1-6, persons skilled in the art will understand that any system configured to perform the method steps, in any order, is within the scope of the present invention.

As shown, a method 700 begins at step 702, where row transform 610 of FIG. 6 receives dequantized coefficients 600 associated with a residual frame of sample values from dequantization/scaling 530 of FIG. 5. Dequantized coefficients 600 describe at least a portion of the residual frame of sample values in the frequency domain, and may be upscaled to a higher bit depth by row transform 610 or prior to being received by row transform 610.

At step 704, row transform 610 performs a row-based inverse transform on dequantized coefficients 600 to generate a row-transformed portion 612 of the residual frame of sample values. In so doing, row transform 610 performs the row-based inverse transform for each row of coefficients in dequantized coefficients 600 or each row of coefficients within a given block of coefficients. In one embodiment, the row-based inverse transform is an inverse discrete cosine transform.

At step 706, column transform 620 performs a column-based inverse transform on row-transformed portion 612 of the residual frame of sample values to generate a reconstructed version 622 of the residual frame of sample values. Column transform 620 performs the column-based inverse transform for each column of coefficients in row-transformed portion 612 of the residual frame of sample values or each column of coefficients within a given block of coefficients. In one embodiment, the column-based inverse transform is an inverse discrete cosine transform. Reconstructed version 622 of the residual frame of sample values includes one or more blocks of samples.

At step 708, dithering 630 selects a first sample in reconstructed version 622 of the residual frame of sample values. Dithering 630 can implement any technically feasible selection criteria to select the first sample. In one embodiment, dithering 630 may select the first sample based on attributes of a block that includes the first sample and one or more threshold values. In another embodiment, dithering 630 may select the first sample based on attributes of dequantized coefficients 600 used to generate the first sample.

At step 710, randomization function 632 within dithering 630 generates a first randomized value based on at least one attribute of the first sample. In one embodiment, randomization function 632 implements a pseudo-random array of values, and then generates the randomized value by indexing the pseudo-random array of values based on vertical and/or horizontal coordinates associated with the first sample.

At step 712, randomization function 632 adds the first randomized value to a first sample value associated with the first sample to generate a first randomized sample value. When the randomized value is generated based on vertical and horizontal coordinates of the first sample, the randomized value may be different from other randomized values generated for adjacent samples. Accordingly, randomized sample values generated for adjacent samples that have similar sample values but different coordinates can vary.

At step 714, rounding function 634 performs a rounding operation on the first randomized sample value to generate a first dithered sample value. In one embodiment, rounding function 634 may implement a bit-shift operation to generate the first dithered sample value. The first dithered sample value can subsequently be used to generate one or more pixel values for a frame of reconstructed video data included in output pictures 570. Dithering sample values in the manner described can prevent adjacent blocks of similar pixels from subsequently being rounded to the same value, and can therefore help prevent banding artifacts.

In sum, a decoding pipeline is configured to implement an inverse transform stage that incorporates a randomized dithering operation. The inverse transform stage includes a row transform stage and column transform stage that perform row-based and column-based inverse transform operations, respectively, based on a set of dequantized coefficients to generate a reconstructed version of a residual frame of sample values. For a given sample in the reconstructed version of the residual frame, a randomization function generates a randomized value based on one or more attributes of the sample. The randomized value is combined with a sample value associated with the sample to generate a randomized sample value. A rounding function then rounds the randomized sample value to a lower bit depth to generate a dithered sample value. The randomized dithering operation can be selectively performed on specific blocks of coefficients that meet certain criteria.

At least one technical advantage of the disclosed techniques relative to the prior art is that the disclosed techniques enable the decoding pipeline to reduce the appearance of banding artifacts in reconstructed frames of video data, thereby resulting in greater overall visual quality and higher-quality viewing experiences when streaming media titles. Another technical advantage of the disclosed techniques is that incorporating randomized dithering operations into the inverse transform stage does not require the addition of any post-processing operations to the decoding pipeline. Accordingly, the disclosed techniques can be implemented without introducing significant delays during playback of a media title. Yet another technical advantage of the disclosed techniques is that the disclosed decoding pipeline can be deployed to different types of endpoint devices, which can lead to more consistent debanding performance and visual quality across different endpoint devices having different hardware and/or software configurations. These technical advantages provide one or more technological improvements over prior art approaches.
1. Some embodiments include a computer-implemented method for reducing banding artifacts in decoded video data, the method comprising performing a set of transform operations on a first block of coefficients associated with a frame of encoded video data to generate a first block of samples, determining that a first sample included in the first block of samples meets a first criterion, generating a first randomized value based on at least one attribute of the first sample, modifying a first sample value associated with the first sample based on the first randomized value to generate a first dithered sample value, and generating a first portion of decoded video data based on the first dithered sample value.
2. The computer-implemented method of clause 1, wherein performing the set of transform operations comprises performing a row-based inverse transform operation on the first block of coefficients to generate a row-transformed portion of a residual frame of sample values, and performing a column-based inverse transform operation on the row-transformed portion of the residual frame of sample values to generate a reconstructed version of the residual frame of sample values that includes the first block of samples.
3. The computer-implemented method of any of clauses 1-2, wherein the first block of coefficients corresponds to a residual frame of sample values that is represented in the frequency domain, and the first block of samples corresponds to a reconstructed version of the residual frame of sample values that is represented in the spatial domain.
4. The computer-implemented method of any of clauses 1-3, wherein determining that the first sample meets the first criterion comprises determining that a number of non-zero coefficients in the first block of coefficients exceeds a threshold value.
5. The computer-implemented method of any of clauses 1-4, wherein determining that the first sample meets the first criterion comprises determining that a number of non-zero coefficients in the first block of coefficients that correspond to a first range of frequency values exceeds a threshold value.
6. The computer-implemented method of any of clauses 1-5, wherein determining that the first sample meets the first criterion comprises determining that a block size associated with the first block of coefficients is less than a threshold value.
7. The computer-implemented method of any of clauses 1-6, wherein generating the first randomized value based on at least one attribute of the first sample comprises indexing an array of values based on a set of coordinates associated with the first sample.
8. The computer-implemented method of any of clauses 1-7, wherein modifying the first sample value comprises adding the first randomized value to the first sample value to generate a first randomized sample value, and performing a bit shift operation on the first randomized sample value to generate the first dithered sample value.
9. The computer-implemented method of any of clauses 1-8, further comprising generating the first block of coefficients by determining that a first block of dequantized coefficients associated with the frame of encoded video data meets a size criterion, and upscaling the first block of dequantized coefficients to generate the first block of coefficients.
10. The computer-implemented method of any of clauses 1-9, further comprising performing the set of transform operations on a second block of coefficients to generate a second block of samples, determining that a second sample included in the second block of samples does not meet the first criterion, and generating a second portion of decoded video data based on a second sample value associated with the second sample.
11. Some embodiments include one or more non-transitory computer-readable media including instructions that, when executed by one or more processors, cause the one or more processors to reduce banding artifacts in decoded video data by performing the steps of performing a set of transform operations on a first block of coefficients associated with a frame of encoded video data to generate a first block of samples, determining that a first sample included in the first block of samples meets a first criterion, generating a first randomized value based on at least one attribute of the first sample, modifying a first sample value associated with the first sample based on the first randomized value to generate a first dithered sample value, and generating a first portion of decoded video data based on the first dithered sample value.
12. The one or more non-transitory computer-readable media of clause 11, wherein the step of performing the set of transform operations comprises performing a row-based inverse transform operation on the first block of coefficients to generate a row-transformed portion of a residual frame of sample values, and performing a column-based inverse transform operation on the row-transformed portion of the residual frame of sample values to generate a reconstructed version of the residual frame of sample values that includes the first block of samples.
13. The one or more non-transitory computer-readable media of any of clauses 11-12, wherein the first block of coefficients corresponds to a residual frame of sample values that is represented in the frequency domain, and the first block of samples corresponds to a reconstructed version of the residual frame of sample values that is represented in the spatial domain.
14. The one or more non-transitory computer-readable media of any of clauses 11-13, wherein the step of generating the first randomized value based on at least one attribute of the first sample comprises indexing an array of values based on a set of coordinates associated with the first sample.
15. The one or more non-transitory computer-readable media of any of clauses 11-14, wherein the step of modifying the first sample value comprises adding the first randomized value to the first sample value to generate a first randomized sample value, and performing a bit shift operation on the first randomized sample value to generate the first dithered sample value.
16. The one or more non-transitory computer-readable media of any of clauses 11-15, further comprising the step of generating the first block of coefficients by determining that a first block of dequantized coefficients associated with the frame of encoded video data meets a size criterion, and upscaling the first block of dequantized coefficients to generate the first block of coefficients.
17. The one or more non-transitory computer-readable media of any of clauses 11-16, further comprising the steps of performing the set of transform operations on a second block of coefficients to generate a second block of samples, determining that a second sample included in the second block of samples does not meet the first criterion, and generating a second portion of decoded video data based on a second sample value associated with the second sample.
18. The one or more non-transitory computer-readable media of any of clauses 11-17, wherein a bit depth associated with the first dithered sample value corresponds to a bit depth associated with the first portion of decoded video data.
19. The one or more non-transitory computer-readable media of any of clauses 11-18, wherein the set of transform operations includes at least one inverse discrete cosine transform operation.
20. Some embodiments include a system comprising one or more memories storing instructions, and one or more processors coupled to the one or more memories that, when executing the instructions, perform the steps of performing a set of transform operations on a first block of coefficients associated with a frame of encoded video data to generate a first block of samples, determining that a first sample included in the first block of samples meets a first criterion, generating a first randomized value based on at least one attribute of the first sample, modifying a first sample value associated with the first sample based on the first randomized value to generate a first dithered sample value, and generating a first portion of decoded video data based on the first dithered sample value.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for reducing banding artifacts in decoded video data, the method comprising:
performing a set of transform operations on a first block of coefficients associated with a frame of encoded video data to generate a first block of samples;
determining that a first sample included in the first block of samples meets a first criterion;
generating a first randomized value based on at least one attribute of the first sample;
modifying a first sample value associated with the first sample based on the first randomized value to generate a first dithered sample value; and
generating a first portion of decoded video data based on the first dithered sample value.

2. The computer-implemented method of claim 1, wherein performing the set of transform operations comprises:
performing a row-based inverse transform operation on the first block of coefficients to generate a row-transformed portion of a residual frame of sample values; and
performing a column-based inverse transform operation on the row-transformed portion of the residual frame of sample values to generate a reconstructed version of the residual frame of sample values that includes the first block of samples.

3. The computer-implemented method of claim 1, wherein the first block of coefficients corresponds to a residual frame of sample values that is represented in the frequency domain, and the first block of samples corresponds to a reconstructed version of the residual frame of sample values that is represented in the spatial domain.

4. The computer-implemented method of claim 1, wherein determining that the first sample meets the first criterion comprises determining that a number of non-zero coefficients in the first block of coefficients exceeds a threshold value.

5. The computer-implemented method of claim 1, wherein determining that the first sample meets the first criterion comprises determining that a number of non-zero coefficients in the first block of coefficients that correspond to a first range of frequency values exceeds a threshold value.

6. The computer-implemented method of claim 1, wherein determining that the first sample meets the first criterion comprises determining that a block size associated with the first block of coefficients is less than a threshold value.

7. The computer-implemented method of claim 1, wherein generating the first randomized value based on at least one attribute of the first sample comprises indexing an array of values based on a set of coordinates associated with the first sample.

8. The computer-implemented method of claim 1, wherein modifying the first sample value comprises:
adding the first randomized value to the first sample value to generate a first randomized sample value; and
performing a bit shift operation on the first randomized sample value to generate the first dithered sample value.

9. The computer-implemented method of claim 1, further comprising generating the first block of coefficients by:
determining that a first block of dequantized coefficients associated with the frame of encoded video data meets a size criterion; and
upscaling the first block of dequantized coefficients to generate the first block of coefficients.

10. The computer-implemented method of claim 1, further comprising:
performing the set of transform operations on a second block of coefficients to generate a second block of samples;
determining that a second sample included in the second block of samples does not meet the first criterion; and
generating a second portion of decoded video data based on a second sample value associated with the second sample.

11. One or more non-transitory computer-readable media including instructions that, when executed by one or more processors, cause the one or more processors to reducing banding artifacts in decoded video data by performing the steps of:
performing a set of transform operations on a first block of coefficients associated with a frame of encoded video data to generate a first block of samples;
determining that a first sample included in the first block of samples meets a first criterion;
generating a first randomized value based on at least one attribute of the first sample;
modifying a first sample value associated with the first sample based on the first randomized value to generate a first dithered sample value; and
generating a first portion of decoded video data based on the first dithered sample value.

12. The one or more non-transitory computer-readable media of claim 11, wherein the step of performing the set of transform operations comprises:
performing a row-based inverse transform operation on the first block of coefficients to generate a row-transformed portion of a residual frame of sample values; and
performing a column-based inverse transform operation on the row-transformed portion of the residual frame of sample values to generate a reconstructed version of the residual frame of sample values that includes the first block of samples.

13. The one or more non-transitory computer-readable media of claim 11, wherein the first block of coefficients corresponds to a residual frame of sample values that is represented in the frequency domain, and the first block of samples corresponds to a reconstructed version of the residual frame of sample values that is represented in the spatial domain.

14. The one or more non-transitory computer-readable media of claim 11, wherein the step of generating the first randomized value based on at least one attribute of the first sample comprises indexing an array of values based on a set of coordinates associated with the first sample.

15. The one or more non-transitory computer-readable media of claim 11, wherein the step of modifying the first sample value comprises:
adding the first randomized value to the first sample value to generate a first randomized sample value; and
performing a bit shift operation on the first randomized sample value to generate the first dithered sample value.

16. The one or more non-transitory computer-readable media of claim 11, further comprising the step of generating the first block of coefficients by:
determining that a first block of dequantized coefficients associated with the frame of encoded video data meets a size criterion; and
upscaling the first block of dequantized coefficients to generate the first block of coefficients.

17. The one or more non-transitory computer-readable media of claim 11, further comprising the steps of:
performing the set of transform operations on a second block of coefficients to generate a second block of samples;
determining that a second sample included in the second block of samples does not meet the first criterion; and
generating a second portion of decoded video data based on a second sample value associated with the second sample.

18. The one or more non-transitory computer-readable media of claim 11, wherein a bit depth associated with the first dithered sample value corresponds to a bit depth associated with the first portion of decoded video data.

19. The one or more non-transitory computer-readable media of claim 11, wherein the set of transform operations includes at least one inverse discrete cosine transform operation.

20. A system comprising:
one or more memories storing instructions; and
one or more processors coupled to the one or more memories that, when executing the instructions, perform the steps of:
performing a set of transform operations on a first block of coefficients associated with a frame of encoded video data to generate a first block of samples,
determining that a first sample included in the first block of samples meets a first criterion,
generating a first randomized value based on at least one attribute of the first sample,
modifying a first sample value associated with the first sample based on the first randomized value to generate a first dithered sample value, and
generating a first portion of decoded video data based on the first dithered sample value.
